(19) United States
(12) Patent Application Publication
(10) Pub. No.: US 2014/0372151 A1
(43) Pub. Date: Dec. 18, 2014

(54) PROVISION OF INSURANCE PRODUCTS

(71) Applicant: TollShare, Inc., Danville, CA (US)

(72) Inventors: Murali M. Karamchedu, Portland, OR (US); Ravi Asnani, Los Angeles, CA (US); Sanjay Nambiar, Los Angeles, CA (US)

(21) Appl. No.: 13/918,795

(22) Filed: Jun. 14, 2013

(51) Int. Cl. G06Q 40/08

(52) U.S. Cl. CPC G06Q 40/08
USPC 705/4

(57) ABSTRACT

In embodiments, methods, storage media, and apparatuses are described that are associated with provisioning of insurance products. In various embodiments, a request for an insurance product associated with an event may be received. A plurality of insurance underwriters may be identified that agree to automated payment of individual payment amounts upon occurrence of the event. Assets and/or lines of credit of the insurance underwriters may be encumbered to provide for automated taking of the individual payment amounts upon occurrence of the event. Other embodiments may be described and claimed.

### TECHNICAL FIELD

The present disclosure relates to the field of data processing, in particular, to apparatuses, methods and storage media associated with provision and underwriting of insurance products.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Individuals and companies participate in an ever-increasing range of activities, both commercial and recreational. Many of these activities involve degrees of risk, and in particular financial risk. In order to mitigate this risk, individuals and other entities may seek to purchase insurance which may provide one or more payments in the case of an unwanted event. However, today most insurance are provided by corporations, resulting in individuals and other entities finding it difficult to find insurance that is suited to their particular situation and needs.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for provision of insurance products, in accordance with various embodiments.

FIG. 2 illustrates an example process for providing an insurance product in accordance with various embodiments.

FIG. 3 illustrates an example process for receiving insurance underwriting offers in accordance with various embodiments.

FIG. 4 illustrates an example process for receiving a request for an insurance product in accordance with various embodiments.

FIG. 5 illustrates an example process for generating an insurance product, in accordance with various embodiments.

FIG. 6 illustrates an example process for sharing premium from an insurance product, in accordance with various embodiments.

FIG. 7 illustrates an example process for providing an insurance payment in accordance with various embodiments.

FIG. 8 illustrates an example computing environment suitable for practicing various aspects of the present disclosure, in accordance with various embodiments.

FIG. 9 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

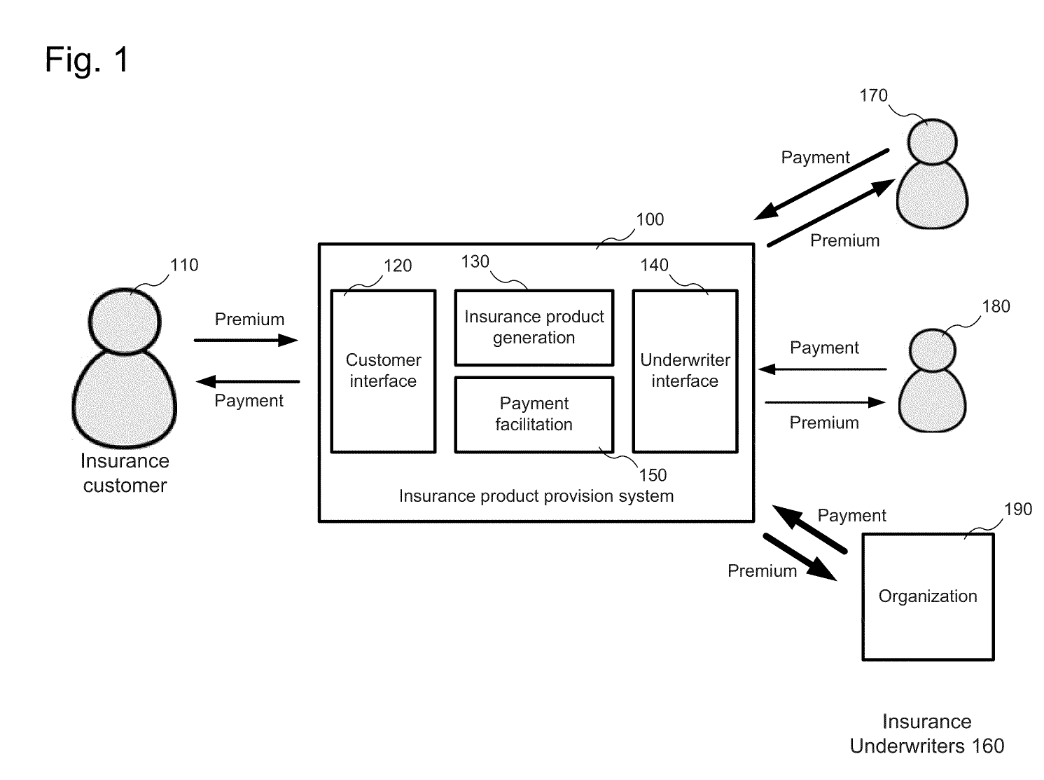

Referring now to FIG. 1, an example arrangement for provision of insurance products is shown in accordance with various embodiments. In various embodiments, an insurance product provision system 100 (“IPPS 100”) may be configured to interact with an insurance customer 110 to generate and provide one or more insurance products to the insurance customer 110. In various embodiments, the IPPS 100 may be configured to generate an insurance product that describes a payment amount as well as a triggering event and directs a payment to the insurance customer 110 upon the occurrence of a triggering event. In various embodiments, the triggering event may include various events associated with the insurance customer, such as medical events, destruction or damage to property, weather or other external force-based events, business events, etc. In various embodiments, the triggering event may not be associated directly with the insurance customer 110, but instead may be associated with another entity, such as a business, a relative, or another individual. In various embodiments, the insurance product may describe additional limitations and/or qualifications relating to the payment and/or triggering event, such as may be prescribed by relevant city, state, and/or national law.

In various embodiments, the IPPS 100 may be configured to facilitate underwriting of the payment by one or more insurance underwriters 160 upon occurrence of the triggering event. In various embodiments, the IPPS 100 may be configured to facilitate underwriting by individuals acting as insurance underwriters 160, such as illustrated individuals 170 and 180. In various embodiments, the IPPS 100 may be configured to facilitate underwriting by non-individual insurance underwriters, such as by organization 190, which, in various embodiments, may include for-profit and non-profit organizations.

In various embodiments, the IPPS 100 may be configured to facilitate the underwriting by encumbering financial resources of the insurance underwriters 160. For example, in various embodiments, the IPPS 100 may be configured to obtain an authorization to take an individual payment amount from an insurance underwriter 160 upon occurrence of the triggering event. In some embodiments, the IPPS 100 may be configured to obtain an authorization to take the individual payment amount out of a line of credit or credit card under control of an insurance underwriter (referred to herein generally as “a line of credit”) or out of a bank account. In such embodiments, the insurance underwriter 160 may be facilitated in underwriting an insurance product without a requirement that the insurance underwriter provide funds at the time of creation of the product. Instead, in such embodiments, the insurance underwriter 160 may agree to the authorization of an individual payment amount without needing to have the payment on-hand at the time the insurance underwriter 160 agrees to underwrite the insurance product. Additionally, the insurance underwriter 160 may be facilitated by the IPPS 100 in entering into agreements to underwrite an insurance product based on the insurance underwriter's available credit rather than other resources, such as liquid funds or other capital.

In various embodiments, the IPPS 100 may be configured to facilitate collection and sharing of a premium from the insurance customer 110 to the insurance underwriters 160. Thus, in various embodiments, the IPPS 100 may facilitate the division of an insurance premium between various insurance underwriters 160. In various embodiments, this division may be performed at least in part based on an amount of the payment the insurance underwriter 160 has agreed to pay upon occurrence of the triggering event. Thus, as shown, the individual insurance underwriter 180, which has agreed to pay less of the payment than the individual insurance underwriter 170, is also receiving less of the premium. Similarly, the organization insurance underwriter 190, which has agreed to pay a larger amount, receives a larger premium amount. In various embodiments, the IPPS 100 may be configured to facilitate collection of premiums and payment of divisions of the premiums on a recurring basis, such as, for example, monthly or yearly.

In various embodiments, the IPPS 100 may include one or more computing devices as described herein. In various embodiments the IPPS 100 may include one or more modules configured to be operated on the one or more computing devices to perform techniques described herein. While particular modules are illustrated and described, in various embodiments, techniques described herein may be performed by other modules, combined into modules, and/or omitted.

In various embodiments, the IPPS 100 may include a customer interface module 120, which may be configured to receive one or more requests for insurance products from the insurance customer 110 and to provide insurance products to the insurance customer. The customer interface module 120 may also facilitate payment of premiums by the insurance customer 110 as well as payment to the insurance customer 110 upon occurrence of a triggering event. In various embodiments, the IPPS 100 may include a underwriter interface 140 which may be configured to receive offers to underwrite insurance products from the insurance underwriters 160, as well as to facilitate payment of divisions of premium amounts to the insurance underwriters 160.

In various embodiments, the IPPS 100 may include an insurance product generation module 130, which may be configured to generate one or more insurance products and to provide these to the insurance customer 110. In various embodiments, the insurance product generation module 130 may be configured to generate insurance terms, premium amounts, and/or payment amounts based at least in part on requests from the insurance customer 110 for insurance products and/or offers to underwrite insurance products received from the insurance underwriters 160. In various embodiments the insurance product generation module 130 may also be configured to select one or more insurance underwriters 160 to underwrite a particular insurance product. Particular details of insurance product generation and insurance underwriter selection are described below.

In various embodiments, the IPPS 100 may also include a payment facilitation module 150. In various embodiments, the payment facilitation module 150 may be configured to divide received premium payments between the insurance underwriters 160 and facilitate payment of the divided premiums between the insurance underwriters 160. In various embodiments, the payment facilitation module 150 may also be configured to facilitate payment from the insurance underwriters 160 to the insurance customer 110 after occurrence of a triggering event. In various embodiments, the payment facilitation module 150 may be configured to perform automated authorized payment from resources under control of the insurance underwriters 160, such as by obtaining authorization to pay from credit cards, lines of credit, and/or bank accounts under control of one or more insurance underwriters 160. Examples of payment facilitation are described below.

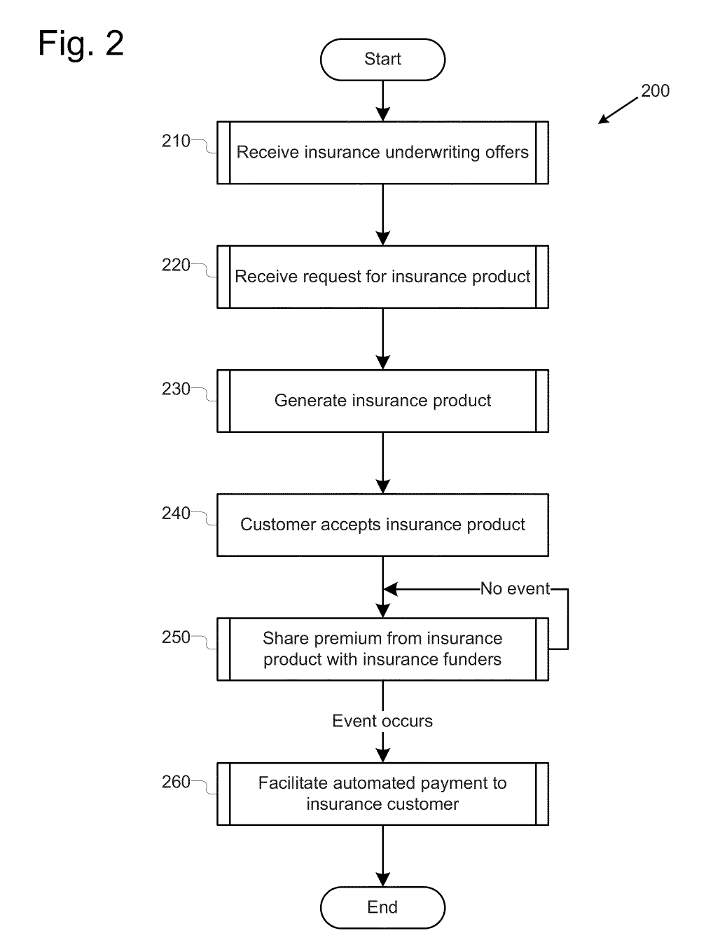

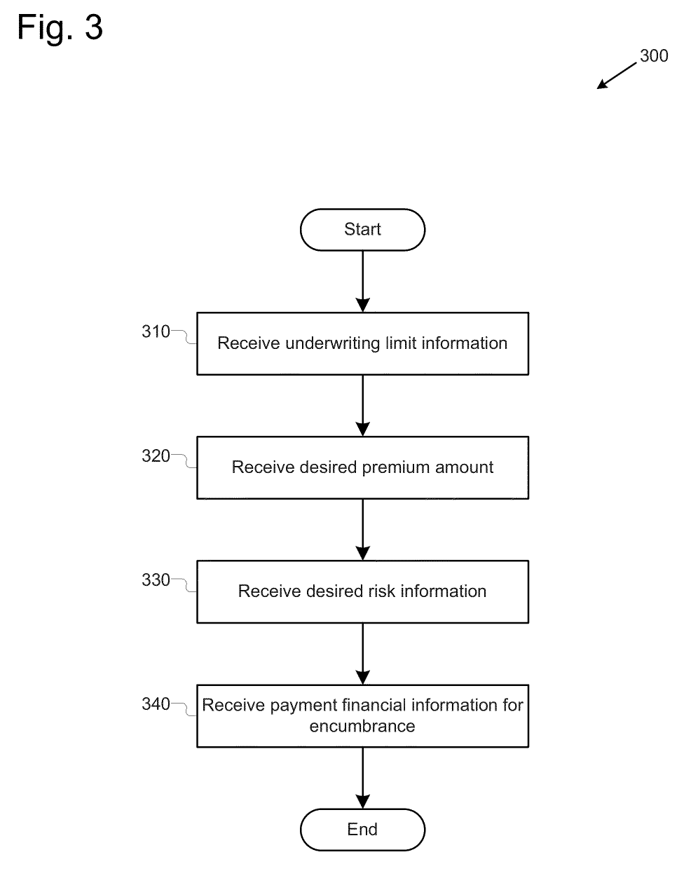

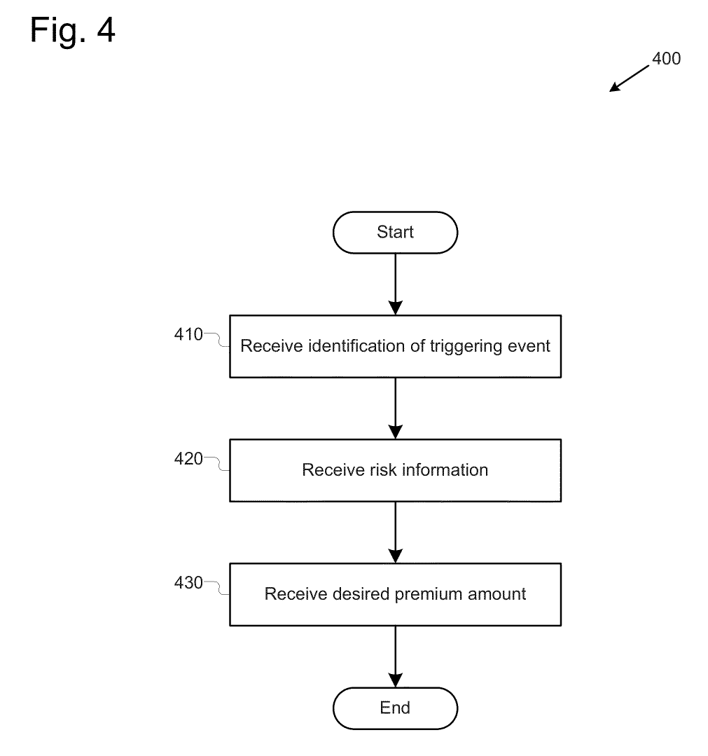

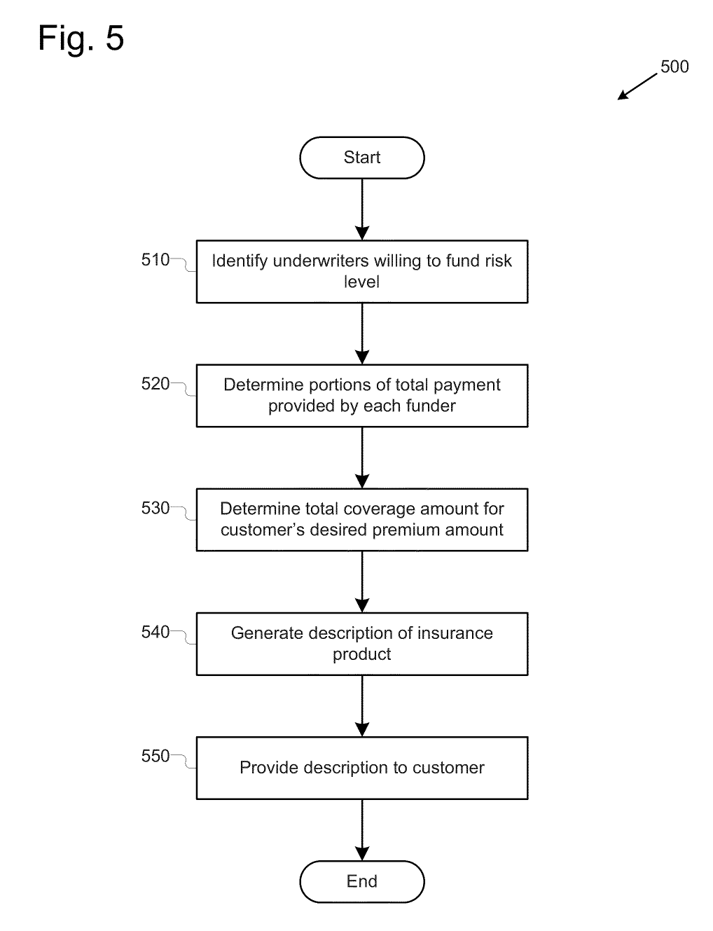

Referring now to FIG. 2, an example process 200 for providing an insurance product is illustrated in accordance with various embodiments. While FIG. 2 illustrates particular operations in a particular order, in various embodiments, the operations may be combined, split into parts, and/or omitted. The process may begin at operation 210, where the IPPS 100 may receive insurance underwriting offers from one or more insurance underwriters 160. Particular examples of operation 210 are described below with reference to FIG. 3. Next, at operation 220, the IPPS may receive a request for an insurance product from the insurance customer 110. Particular examples of operation 220 are described below with reference to FIG. 4. Next, at operation 230, the IPPS 100 may generate the insurance product for the insurance customer 110. Particular examples of operation 230 are described below with reference to FIG. 5.

In various embodiments, through performance of operations 220 and 230, the IPPS 100 may facilitate the performance of one or more types of auctions for insurance products. In various embodiments, the IPPS 100 may facilitate performance of a forward auction for an insurance product, where, for example, the insurance customer 110 may bid a premium amount for a given insurance product. In various embodiments, the IPPS 100 may facilitate performance of a reverse auction, where, for example, the insurance customer 110 may request a specific premium amount and receive offers of insurance products to choose from. Thus, in a reverse auction, as illustrated in process 200, the IPPS 100 may receive a request along with a premium amount from the insurance customer 110 at operation 220 before generating an insurance product at operation 230. By contrast, in an embodiment where a forward auction is facilitated, the IPPS 100 may generate insurance products before receiving bids from insurance customers 110. Examples of these auctions are described below.

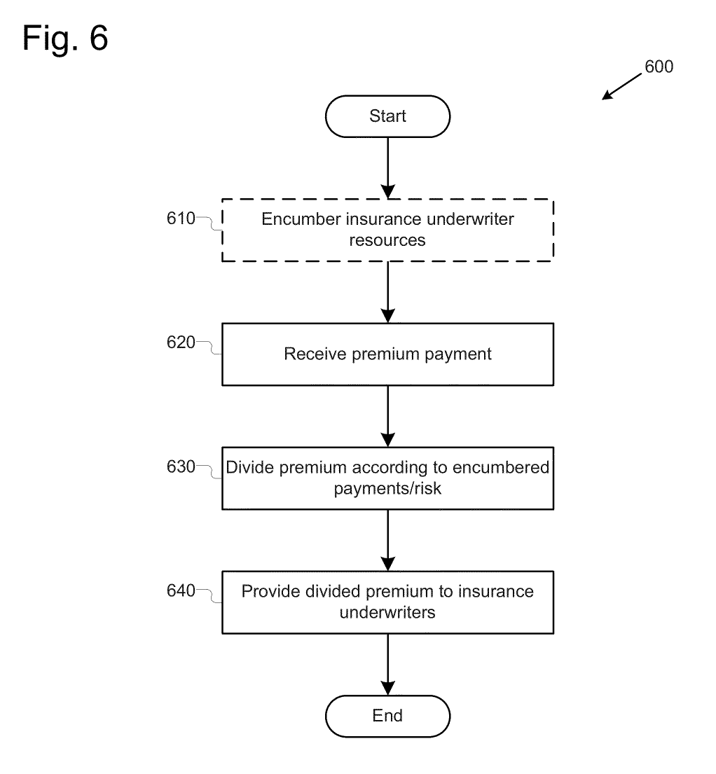

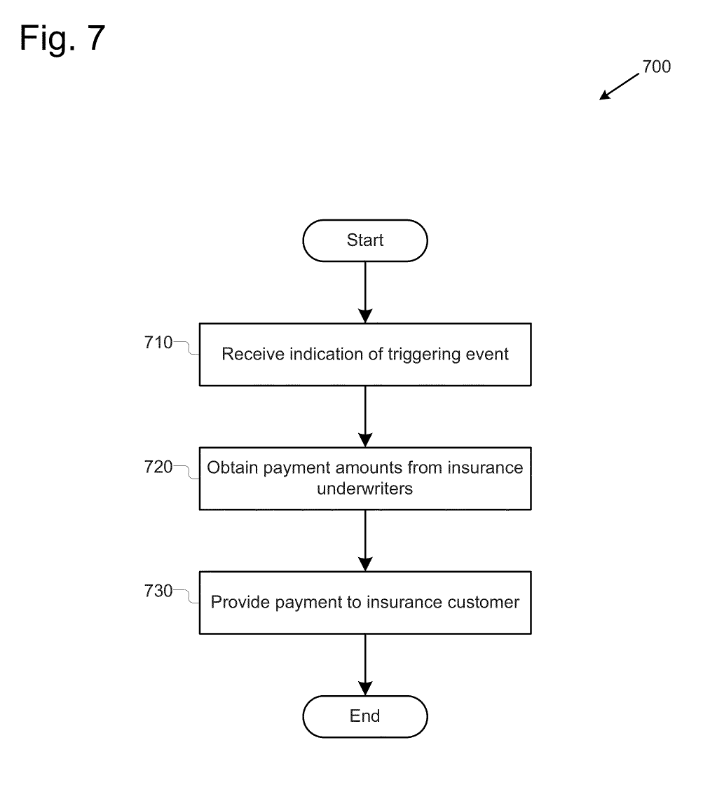

Next, at operation 240, the insurance customer 110 may accept the generated insurance product. In embodiments where a forward auction is facilitated (not illustrated) at operation 240, the IPPS 110 may receive bids for a generated insurance product and select an offered bid. After acceptance, at operation 250, the IPPS 100 may facilitate sharing of premiums received from the insurance customer 110 with the insurance underwriters 160. Particular examples of operation 250 are described below with reference to FIG. 6. In various embodiments, this sharing of premiums may repeat, such as so long as a triggering event associated with the insurance product does not occur. However, if the triggering event does occur, then at operation 260, the IPPS 100 may facilitate automated payment of the payment amount associated with the insurance product to the insurance customer. Particular examples of operation 260 are described below with reference to FIG. 7. The process may then end.

Referring now to FIG. 3, an example process 300 for receiving insurance underwriting offers is illustrated in accordance with various embodiments. While FIG. 3 illustrates particular operations in a particular order, in various embodiments, the operations may be combined, split into parts, and/or omitted. In various embodiments, process 300 may be performed by the insurance underwriter interface module 140. In various embodiments, process 300 may performed for each insurance underwriter 160.

The process may begin at operation 310, where the IPPS 100 may receive underwriting limit information for the insurance underwriter 160. For example, the IPPS 100 may receive an indication of maximum amount the insurance underwriter 160 may be willing to underwrite. In various embodiments, at operation 310 the insurance underwriter 160 may provide an indication of available credit limits that it is willing to authorize payment out of In various embodiments, the underwriting limit information received at operation 310 may be indicated on a per-insurance product basis, and/or as a total limit on all insurance products.

Next, at operation 320, the IPPS 100 may receive a desired premium amount from the insurance underwriter 160. In various embodiments, the IPPS 100 may facilitate indication of different desired premiums for different levels of underwriting; thus, an insurance underwriter 160 may indicate that it is willing to provide additional underwriting for a higher received premium. Next, at operation 330, the IPPS 100 may receive desired risk information. In various embodiments, the IPPS 100 may thus receive an indication of a likelihood (which may be measured as a percentage or in some other metric) of a triggering event occurring; this likelihood may then be associated with the insurance underwriter 160's underwriting offer.

Next, at operation 340, the IPPS 100 may receive financial information for the insurance underwriter 160. In various embodiments, this financial information may be utilized by the IPPS 100 to facilitate payment to the insurance customer 110 upon occurrence of a triggering event. In various embodiments, the financial information may facilitate the IPPS 100 in encumbering the insurance underwriter 160 to better ensure payment. For example, the IPPS 100 may receive financial information that allows the IPPS 100 to place a spending authorization against a line of credit of the insurance underwriter 160. In various embodiments, this financial information may include one or more contract agreements between the insurance underwriter 160 and the IPPS 100 (or an entity associated with the IPPS 100) to provide legal authorization for future payments. In various embodiments, the financial information received at operation 340 may include authorization for the IPPS 100 to repeat obtaining authorization to encumber the insurance underwriter 160, such as if a previous authorization times out. The process may then end.

Referring now to FIG. 4, an example process 400 for receiving a request for an insurance product is illustrated in accordance with various embodiments. While FIG. 4 illustrates particular operations in a particular order, in various embodiments, the operations may be combined, split into parts, and/or omitted. In various embodiments, process 400 may be performed by the customer interface module 120. In various embodiments, performance of process 400 of FIG. 4, along with process 500 of FIG. 5, may facilitate performance of a reverse auction for insurance products. In other embodiments, performance of processes 400 and 500 may facilitate performance of a forward auction.

The process may begin at operation 410, where the IPPS 100 may receive an identification of one or more triggering events. As discussed above, in various embodiments, triggering events may include health based events, such as physician visits, prescription filling, medical procedures, etc. In some embodiments, triggering events may include business-based events, such as breaches of contract, late shipments, receipt of goods of substandard quality, etc. In other embodiments, other triggering events may be received. In some embodiments, triggering events may be described explicitly, while in others, the insurance customer 110 may generally describe a type of insurance (i.e. health or home insurance) without specifying particular triggering events. In such cases, the IPPS 100 may generate an insurance product with specific events based on the general request. In various embodiments, at operation 410, the IPPS 100 may also receive a desired payment amount for the triggering event. In various embodiments, the payment amount may be indicated as a total amount per event, and/or as amounts over time.

Next, at operation 420, the IPPS 100 may receive risk information relating to the requested insurance product. In various embodiments, the risk information my include data relating to an actual numerical risk of a triggering event occurring. In other embodiments, risk information may include information that facilitates the IPPS 100 in determining risk, such as the insurance customer 110's health or business history, weather patterns (such as for an agricultural insurance product), mitigating resources available to the insurance customer 110, etc. Next, at operation 430, the IPPS 100 may receive a desired premium amount from the insurance customer. The premium amount, in various embodiments, may include an amount that the insurance customer 110 may be willing to pay per time period for the type of coverage identified through the received triggering event (and possible payment amount) information previously received. The process may then end.

It may be noted that, in other embodiments, a forward auction may be used instead of a reverse auction. Thus, the insurance customer 110 may not provide a desired premium amount before an insurance product is generated. In such embodiments, the insurance product may even be generated (such as through operation of process 500 of FIG. 5) before receipt of information from the insurance customer 110. In such cases, the insurance customer may bid a premium amount after generation of the insurance product.

Referring now to FIG. 5 an example process 500 for generating an insurance product is illustrated in accordance with various embodiments. While FIG. 5 illustrates particular operations in a particular order, in various embodiments, the operations may be combined, split into parts, and/or omitted. In various embodiments, process 500 may be performed by the insurance product generation module 130. As discussed above, in various embodiments, the IPPS 100 may perform process 500 in order to generate an insurance product after receipt of a desired premium amount from an insurance customer as part of a reverse auction.

The process may begin at operation 510, where the IPPS 100 may identify underwriters who have indicated they are willing to underwrite a particular risk level for the requested insurance product. In various embodiments, the risk level may be determined from the risk information provided at operation 430. In some embodiments, the IPPS 100 may identify those underwriters that are willing to provide underwriting for lowest premium levels for the given risk, and/or at highest premium levels for the given risk.

Next, at operation 520, the IPPS may determine the portions of the payment to be provided by the insurance underwriters 160. In various embodiments, this determination may be based on the insurance underwriters' underwriting limits as well as identified desired risks. Next, at operation 530, the IPPS 100 may determine a total coverage amount for the insurance customer 110's desired premium based on the desired premiums identified by the selected underwriters. Next, at operation 540, the IPPS 100 may generate a description of the insurance product. In various embodiments, the description may include a description of one or more of payment amounts, triggering events, premium, terms and conditions of the insurance product, etc. Next, at operation 550, the IPPS 100 may provide the description to the insurance customer 110. The process may then end.

In other embodiments, the IPPS 100 may generate the insurance product based on underwriter-provided information without having received a desired premium amount from an insurance customer. The IPPS 100 may then receive bids for the insurance product, thereby facilitating a forward auction for the insurance product.

Referring now to FIG. 6, an example process 600 for sharing a premium from an insurance product is illustrated in accordance with various embodiments. While FIG. 6 illustrates particular operations in a particular order, in various embodiments, the operations may be combined, split into parts, and/or omitted. In various embodiments, process 600 may be performed by the payment facilitation module 150. The process may begin at operation 610, where the payment facilitation module 150 may encumber resources (such as credit lines, credit cards, and/or bank accounts) of insurance underwriters 160. In various embodiments, by encumbering resources, the IPPS 100 may better ensured that underwriting for payments to insurance customers is available prior to payment of premiums to insurance underwriters 160. In some embodiments, this operation may not be performed during every performance of process 600, such as when insurance underwriter resources are already encumbered. In some embodiments, however, if insurance underwriter resources are not currently encumbered, such as due to a credit line authorization time limit, they may be re-encumbered at operation 610

Next, at operation 620, the IPPS 100 may receive a premium payment. In some embodiments, rather than receiving the premium payment directly, the IPPS 100 may receive indication that the premium payment has been paid to another entity. Next, at operation 630, the IPPS 100 may divide the received premium. In various embodiments, this division may be performed according to the encumbered individual payment amounts and/or risk accepted by the insurance underwriters. For example, in some embodiments, the premium may be divided between when insurance underwriters 160 as a pro rata share according to their amount of payment offered. Next, at operation 640, the IPPS 100 may provide (or facilitate provision of) the divided premium to the insurance underwriters. The process may then end.

Referring now to FIG. 7, an example process 700 for providing an insurance payment is illustrated in accordance with various embodiments. While FIG. 7 illustrates particular operations in a particular order, in various embodiments, the operations may be combined, split into parts, and/or omitted. In various embodiments, process 700 may be performed by the payment facilitation module 150. The process may begin at operation 710, where the IPPS 100 may receive an indication that a triggering event has occurred. In various embodiments, the IPPS 100 may receive the indication directly from the insurance customer 110; in others, the IPPS 100 may receive the indication of the triggering event from an entity separate from the insurance customer 100 (such as, for example, a medical provider). Next, at operation 720, the IPPS 100 may automatically obtain individual payment amounts from the insurance underwriters 160. In various embodiments, the individual payment amounts may be obtained from pre-authorized lines of credit, as discussed above. Next, the IPPS 100 may provide payment (or facilitate provision of payment) to the insurance customer 110. The process may then end.

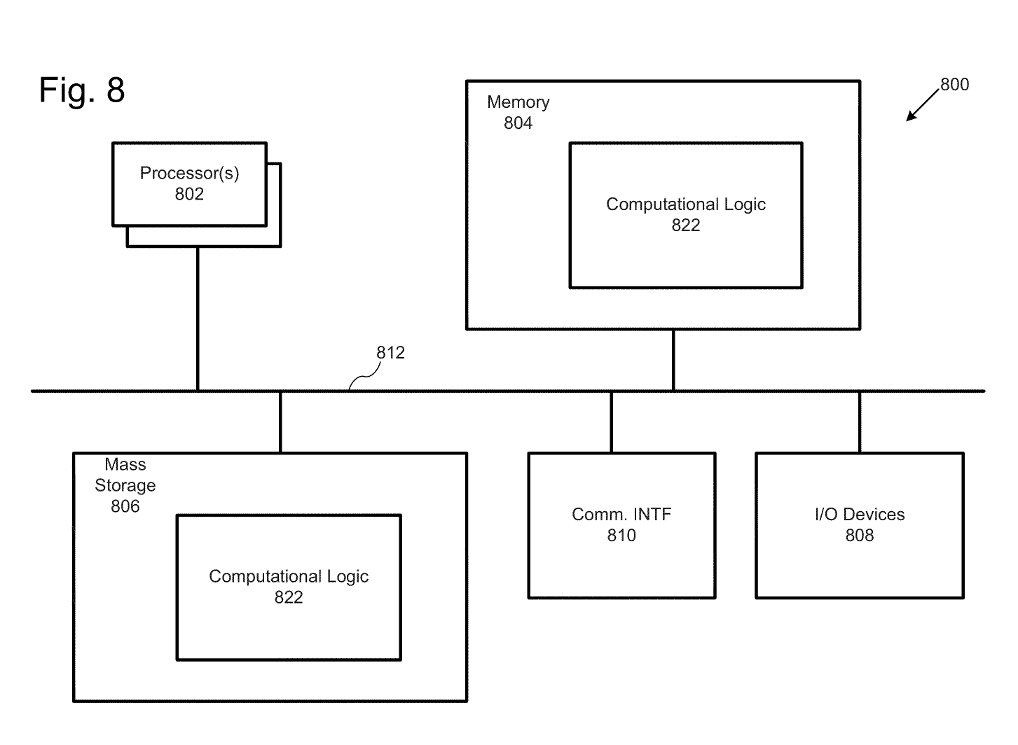

Referring now to FIG. 8, an example computer suitable for practicing various aspects of the present disclosure, including processes of FIGS. 2-7, is illustrated in accordance with various embodiments. As shown, computer 800 may include one or more processors or processor cores 802, and system memory 804. For the purpose of this application, including the claims, the terms “processor” and “processor cores” may be considered synonymous, unless the context clearly requires otherwise. Additionally, computer 800 may include mass storage devices 806 (such as diskette, hard drive, compact disc read only memory (CD-ROM) and so forth), input/output devices 808 (such as display, keyboard, cursor control, remote control, gaming controller, image capture device, and so forth) and communication interfaces 810 (such as network interface cards, modems, infrared receivers, radio receivers (e.g., Bluetooth), and so forth). The elements may be coupled to each other via system bus 812, which may represent one or more buses. In the case of multiple buses, they may be bridged by one or more bus bridges (not shown).

Each of these elements may perform its conventional functions known in the art. In particular, system memory 804 and mass storage devices 806 may be employed to store a working copy and a permanent copy of the programming instructions implementing the modules shown in FIG. 1, and/or the operations associated with techniques shown in FIGS. 2-7. The various elements may be implemented by assembler instructions supported by processor(s) 802 or high-level languages, such as, for example, C, that can be compiled into such instructions.

The permanent copy of the programming instructions may be placed into permanent storage devices 806 in the factory, or in the field, through, for example, a distribution medium (not shown), such as a compact disc (CD), or through communication interface 810 (from a distribution server (not shown)). That is, one or more distribution media having an implementation of the agent program may be employed to distribute the agent and program various computing devices.

The number, capability and/or capacity of these elements 810-812 may vary. Their constitutions are otherwise known, and accordingly will not be further described.

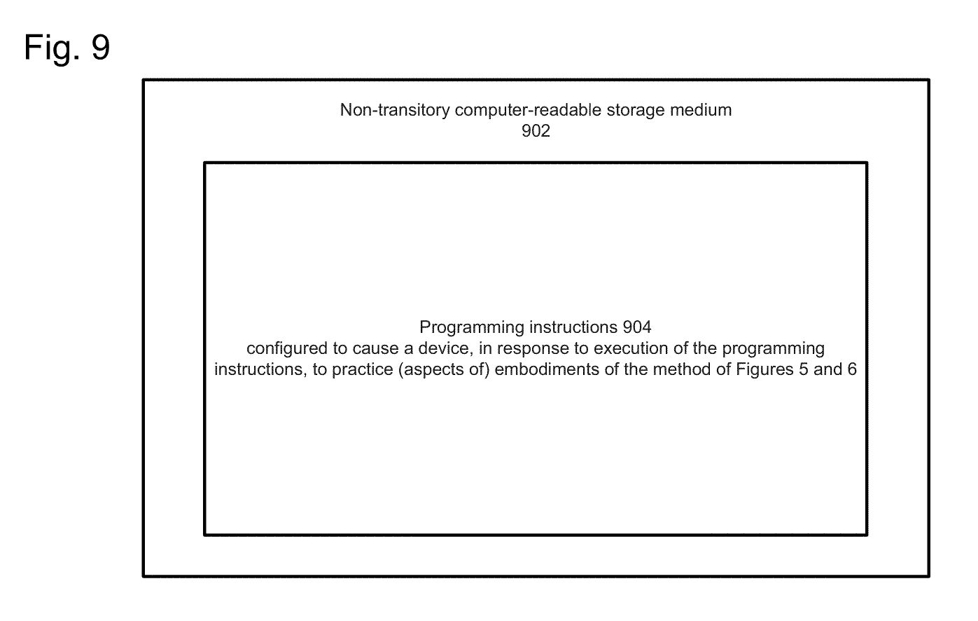

FIG. 9 illustrates an example least one computer-readable storage medium 902 having instructions configured to practice all or selected ones of the operations associated with the techniques earlier described, in accordance with various embodiments. As illustrated, least one computer-readable storage medium 902 may include a number of programming instructions 904. Programming instructions 904 may be configured to enable a device, e.g., computer 800, in response to execution of the programming instructions, to perform, e.g., various operations of processes of FIGS. 2-7, e.g., but not limited to, to the various operations performed to perform generation of insurance products. In alternate embodiments, programming instructions 904 may be disposed on multiple least one computer-readable storage media 902 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

1. A computer-implemented method for developing an insurance product, the method comprising:
receiving, by one or more computing devices, a request for an insurance product associated with an event from an insurance customer;
identifying, by the one or more computing devices, a plurality of insurance underwriters, wherein each insurance underwriter agrees to an automated payment of an individual payment amount from the underwriter to the insurance customer upon occurrence of the event; and
offering, by the one or more computing devices, the insurance product to the insurance customer, the insurance product including an offer to pay the insurance customer upon occurrence of the event and based at least in part on payments agreed to by the plurality of insurance underwriters.

2. The method of claim 1, further comprising receiving, by the one or more computing devices, an agreement from each identified insurance underwriter to allow a line of credit under control of the insurance underwriter to be encumbered to provide for the automated payment of the individual payment amount to be paid out of the line of credit.

3. The method of claim 2, further comprising obtaining, by the one or more computing devices, an authorization hold to take automated payment of the individual payment amount out of the line of credit.

4. The method of claim 3, wherein:
the authorization hold has a time limit; and
the method further comprises obtaining re-authorization to take payment of the individual payment amount out of the line of credit after completion of the time limit.

5. The method of claim 1, wherein the insurance product is associated with a premium amount; and
the method further comprises:
receiving, by the one or more computing devices, an indication of payment of the premium amount from the insurance customer; and
facilitating, by the one or more computing devices, paying a portion of the premium amount to each of the identified insurance underwriters.

6. The method of claim 5, wherein paying a portion of the premium amount to each of the identified insurance underwriters comprises paying respective portions of the premium amount to respective identified insurance underwriters based at least in part on respective individual payment amounts agreed to by the insurance underwriters.

7. The method of claim 5, wherein:
the method further comprises receiving, by the one or more computing devices, for each of a plurality of insurance underwriters, an indication of a desired premium amount requested by the insurance underwriter in order for the insurance underwriter to agree to pay the individual payment amount; and
wherein identifying the identified insurance underwriters comprises identifying insurance underwriters based at least in part on the indications of the desired premium amounts.

8. The method of claim 5, wherein:
the method further comprises receiving, by the one or more computing devices, for each of a plurality of insurance underwriters, an indication of a desired risk requested by the insurance underwriter in order for the insurance underwriter to agree to pay the individual payment amount; and
wherein identifying the identified insurance underwriters comprises identifying insurance underwriters based at least in part on the indications of the desired risks.

9. The method of claim 1, wherein:
receiving a request for the insurance product comprises receiving a desired premium amount in a reverse auction;
identifying a plurality of insurance underwriters comprises selecting the plurality of insurance underwriters based on the desired premium amount; and
offering the insurance product comprises generating the insurance product based at least in part on the selected insurance underwriters.

10. The method of claim 1, wherein:
offering the insurance product comprises generating the insurance product as part of a forward auction; and
the method further comprises receiving one or more bids from the insurance customer for the generated insurance product.

11. One or more computer-readable media including instructions that cause a computing device, in response to execution of the instructions, to:
receive a request for an insurance product associated with an event from an insurance customer;
identify a plurality of insurance underwriters, wherein each insurance underwriter agrees to allow encumbrance of a line of credit under control of the insurance underwriter to facilitate automated payment of an individual payment amount from the underwriter to the insurance customer upon occurrence of the event; and
offer the insurance product to the insurance customer, the insurance product including an offer to pay the insurance customer upon occurrence of the event and based at least in part on the payments agreed to by the insurance underwriters.

12. The computer-readable media of claim 11, wherein the instructions are further configured to cause the computing device to receive an authorization hold to take automated payment of the individual payment amount out of a line of credit under control of the insurance underwriter.

13. The computer-readable media of claim 12, wherein:
the authorization hold has a time limit; and
the instructions are further configured to cause the computing device to obtain re-authorization to take payment of the individual payment amount out of the line of credit after completion of the time limit.

14. The computer-readable media of claim 11, wherein the insurance product is associated with a premium amount; and
the instructions are further configured to cause the computing device to:
receive an indication of payment of the premium amount from the insurance customer; and
facilitate payment of a portion of the premium amount to each of the identified insurance underwriters based at least in part on respective individual payment amounts agreed to by the insurance underwriters.

15. The computer-readable media of claim 14, wherein:
instructions are further configured to cause the computing device to receive, for each of a plurality of insurance underwriters, an indication of a desired premium amount requested by the insurance underwriter in order for the insurance underwriter to agree to pay the individual payment amount; and
wherein identify the identified insurance underwriters comprises identify insurance underwriters based at least in part on the indications of the desired premium amounts.

16. The computer-readable media of claim 14, wherein:
instructions are further configured to cause the computing device to receive, for each of a plurality of insurance underwriters, an indication of a desired risk requested by the insurance underwriter in order for the insurance underwriter to agree to pay the individual payment amount; and
wherein identify the identified insurance underwriters comprises identify insurance underwriters based at least in part on the indications of the desired risks.

17. A computer-implemented method for facilitating underwriting of an insurance product, the method comprising:
receiving an offer by one or more insurance underwriters to underwrite an insurance product associated with an insurance customer and associated with a payment amount from the insurance underwriters to the insurance customer upon meeting a requirement; and
encumbering one or more assets and/or lines of credit of the insurance underwriters, such that upon meeting the requirement to pay the insurance customer, the payment amount can be automatically taken from the one or more assets or lines of credit of the one or more insurance underwriters.

18. The method of claim 17, wherein encumbering the one or more assets and/or lines of credit comprises encumbering individual assets and/or lines of credit for individual payment amounts that are less than the payment amount.

19. The method of claim 17, wherein encumbering the one or more assets and/or lines of credit comprises obtaining an authorization to take automated payment of an individual payment amount out of a credit card associated with an insurance underwriter.

20. The method of claim 19, wherein:
the authorization has a time limit; and
the method further comprises obtaining re-authorization to take payment of the individual payment amount out of the line of credit after completion of the time limit.

21. The method of claim 17, further comprising:
receiving a payment of a premium from the insurance customer; and
paying one or more portions of the premium amount to the one or more insurance underwriters in exchange for the insurance underwriters agreeing to allow encumbrance of the one or more assets and/or lines of credit.

22. One or more computer-readable media including instructions that cause a computing device, in response to execution of the instructions, to:
receive an offer by one or more insurance underwriters to underwrite an insurance product associated with an insurance customer and associated with a payment amount from the insurance underwriters to the insurance customer upon meeting a requirement; and
encumber one or more assets and/or lines of credit of the insurance underwriters, such that upon meeting the requirement to pay the insurance customer, the payment amount can be automatically taken from the one or more assets or lines of credit of the one or more insurance underwriters.

23. The computer-readable media of claim 22, wherein encumber the one or more assets and/or lines of credit comprises encumber individual assets and/or lines of credit for individual payment amounts that are less than the payment amount.

24. The computer-readable media of claim 22, wherein encumber the one or more assets and/or lines of credit comprises obtain an authorization to take automated payment of an individual payment amount out of a credit card associated with an insurance underwriter.

25. The computer-readable media of claim 24, wherein:
the authorization has a time limit; and
the instructions are further configured to obtain re-authorization to take payment of the individual payment amount out of the line of credit after completion of the time limit.

26. The computer-readable media of claim 22, wherein the instructions are further configured to:
receive a payment of a premium from the insurance customer; and
pay one or more portions of the premium amount to the one or more insurance underwriters in exchange for the insurance underwriters agreeing to allow encumbrance of the one or more assets and/or lines of credit.
